(19) United States
(12) Patent Application Publication
(10) Pub. No.: US 2026/0131645 A1
(43) Pub. Date: May 14, 2026

(54) SUSPENSION MEMBER ASSEMBLY

(71) Applicant: TOYOTA JIDOSHA KABUSHIKI KAISHA, Toyota-shi (JP)

(72) Inventors: Takahiro ITO, Toyota-shi (JP); Katsuhiro SAKURAI, Toyota-shi (JP); Takuya KINAMI, Toyota-shi (JP)

(73) Assignee: TOYOTA JIDOSHA KABUSHIKI KAISHA, Toyota-shi (JP)

(21) Appl. No.: 19/263,978

(22) Filed: Jul. 9, 2025

(30) Foreign Application Priority Data
Nov. 14, 2024 (JP) 2024-198683

(51) Int. Cl. B60K 1/00; B60K 1/04

(52) U.S. Cl. CPC B60K 1/00; B60K 2001/0416

(57) ABSTRACT

A suspension member assembly that includes a suspension member attached to a rear portion of a vehicle body, an electric unit mounted on the suspension member, and a front mount and a rear mount that support the electric unit, in which the rear mount is attached to an upper rear portion of the suspension member, and the front mount is attached to right and left front lower portions of the suspension member such that a first load-bearing shaft is inclined rearward and obliquely upward of the vehicle.

### CROSS-REFERENCE TO RELATED APPLICATION

This application claims priority to Japanese Patent Application No. 2024-198683 filed on Nov. 14, 2024. The disclosure of the above-identified application, including the specification, drawings, and claims, is incorporated by reference herein in its entirety.

### BACKGROUND

### 1. Technical Field

The present disclosure relates to a structure of a suspension member assembly that is attached to a rear portion of a vehicle body.

### 2. Description of Related Art

Japanese Unexamined Patent Application Publication No. 2017-100676 (JP 2017-100676 A) describes a front mount that supports a motor in the vertical direction in a rear suspension member on which the motor is mounted.

### SUMMARY

In a case where the front mount and a rear mount of the motor are disposed to be inclined with respect to the horizontal direction, a direction of a torque reaction force of the motor is oblique to the vertical direction. Therefore, as described in JP 2017-100676 A, when a direction in which a load bearing capacity of a mount is large is disposed in the vertical direction, the torque reaction force of the motor is applied with a deviation from the direction in which the load bearing capacity of the mount is large, and the torque reaction force of the motor may not be sufficiently received.

Therefore, an object of the present disclosure is to increase a holding force of an electric unit in a suspension member on which the electric unit is mounted.

A suspension member assembly of the present disclosure is a suspension member assembly including a suspension member that is attached to a rear portion of a vehicle body, an electric unit that is mounted on the suspension member, and right and left front mounts and right and left rear mounts that support the electric unit, in which
the right and left rear mounts are attached to right and left rear upper portions of the suspension member, and
the right and left front mounts are attached to right and left front lower portions of the suspension member such that first load-bearing shafts are inclined rearward and obliquely upward of a vehicle.

As a result, a torque reaction force from drive shafts is applied in a direction orthogonal to a load-bearing shaft having a large load bearing capacity, so that the front mounts can sufficiently receive the torque reaction force. In addition, since the weight of the electric unit is smaller than the torque reaction force, the weight can be supported by the front mounts even when the weight is applied in a direction deviated from a direction orthogonal to the center line of front mounts. Therefore, even in a case where the front mounts and the rear mounts are disposed to be inclined with respect to the horizontal direction, the front mounts can sufficiently receive the weight of the electric unit and the torque reaction force.

In the suspension member assembly of the present disclosure,
the suspension member may be a rectangular frame-shaped member including right and left side beams that are disposed on right and left sides of the vehicle and extend in a vehicle front-rear direction, and a front cross member that connects the right and left side beams in a vehicle width direction,
the right and left side beams may include holes through which drive shafts connected to the electric unit pass,
the right and left rear mounts may be attached to the right and left side beams such that second load-bearing shafts extend in the vehicle width direction behind the holes and above the center of the drive shafts, and
the right and left front mounts may be attached to right and left end portions of the front cross

member below the center of the drive shafts such that the first load-bearing shafts extend in a direction passing through the center of the drive shafts.

In a direction orthogonal to the first load-bearing shafts, the load bearing capacity and the rigidity of the front mounts are increased. Since the direction of the first load-bearing shafts of the front mounts is orthogonal to the vehicle width direction, the front mounts can support the load of the electric unit in the vehicle width direction with high rigidity. In addition, in a direction orthogonal to the second load-bearing shafts, the load bearing capacity and the rigidity of the rear mounts are increased. Since the direction of the second load-bearing shafts of the rear mounts is orthogonal to the vehicle front-rear direction, the rear mounts can support the load of the electric unit in the vehicle front-rear direction with high rigidity. As a result, the holding force in each of the directions of the right and left front mounts and the right and left rear mounts can be increased. In addition, since the direction of the second load-bearing shafts of the right and left rear mounts is orthogonal to a vehicle up-down direction, the rear mounts can support the weight of the electric unit with high rigidity.

According to the present disclosure, it is possible to increase a holding force of an electric unit in a suspension member on which the electric unit is mounted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a rear portion of a vehicle to which a suspension member assembly of an embodiment is mounted;

FIG. 2 is a side view of the suspension member assembly of the embodiment;

FIG. 3 is a perspective view of the suspension member shown in FIG. 1 as viewed from an upper rear oblique direction;

FIG. 4 is a perspective view of the suspension member shown in FIG. 1 as viewed obliquely from the upper front;

FIG. 5 is an explanatory view showing the disposition of the front mount and the rear mount and the support of the electric unit in a vehicle width direction and a vehicle front-rear direction by the front mount and the rear mount; and

FIG. 6 is an explanatory view showing the disposition of the front mount and the rear mount, the direction of the load applied to the front mount and the rear mount by the torque reaction force from the drive shaft, and the support of the weight of the electric unit by the front mount and the rear mount.

### DETAILED DESCRIPTION OF EMBODIMENTS

Hereinafter, a suspension member assembly 80 of the embodiment will be described. First, a vehicle 100 to which a suspension member assembly 80 is mounted will be described. In addition, FR, UP, and RH shown in each of the drawings respectively indicate the front side, the upper side, and the right side of the vehicle 100 to which the suspension member assembly 80 is mounted. In addition, the opposite direction of the FR, UP, RH indicates the rear side, the lower side, and the left side. Hereinafter, when the front-rear, right-left, and up-down directions are simply described, unless otherwise specified, the front-rear direction of the vehicle 100 is the front-rear direction, the right-left direction is the right-left direction, and the up-down direction is the up-down direction. In addition, the front and rear of the front-rear direction of the vehicle 100, the right and left of the right-left direction of the vehicle 100, and the up and down of the up-down direction of the vehicle 100 are the front and rear of the front-rear direction of the suspension member assembly 80, the right and left of the right-left direction of the suspension member assembly 80, and the up and down of the up-down direction of the suspension member assembly 80.

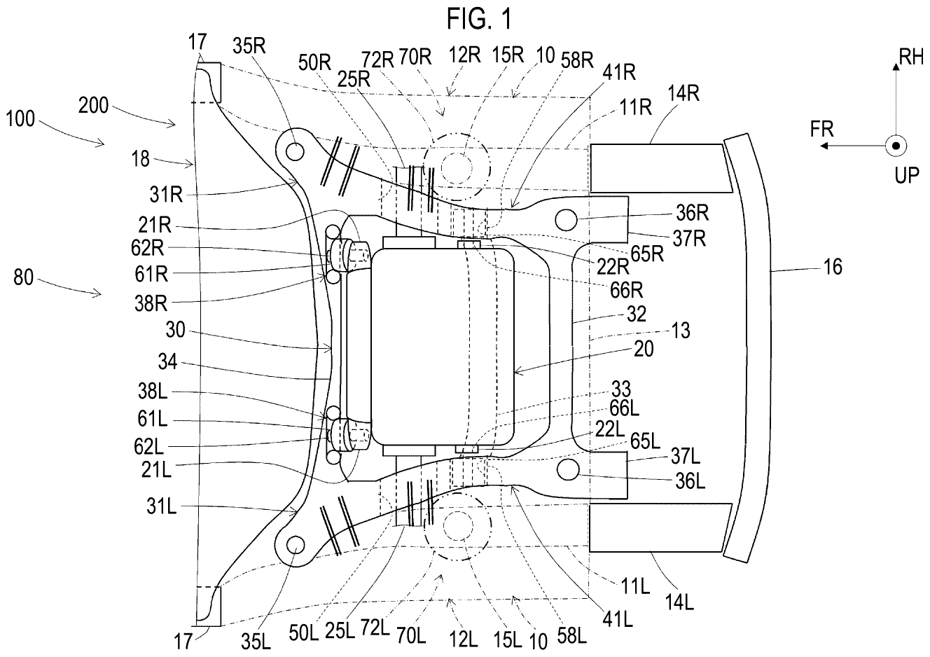

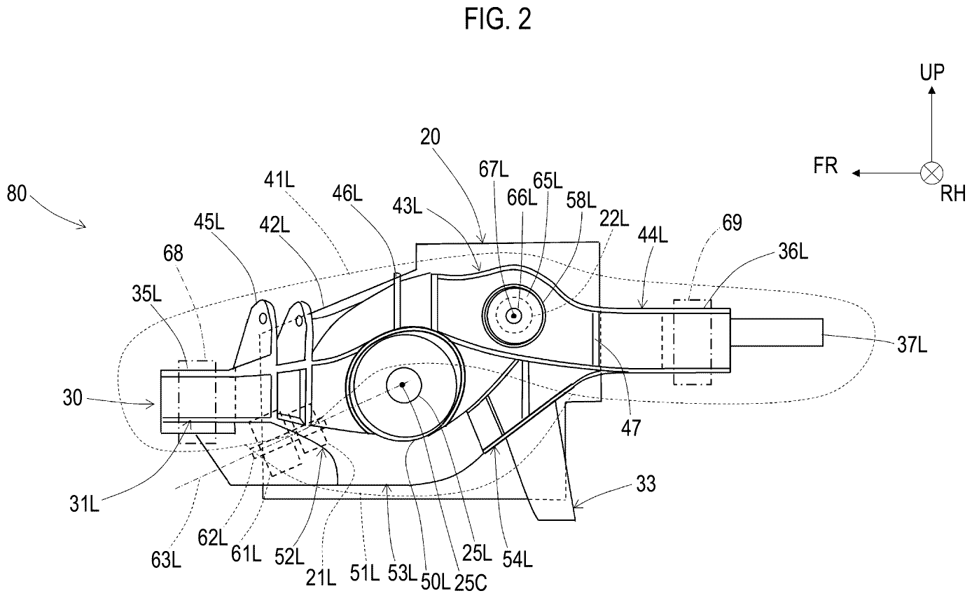

As shown in FIGS. 1 and 2, the vehicle 100 includes a vehicle body 200 and a suspension member assembly 80 attached to a rear portion of the vehicle body 200. The suspension member assembly 80 includes the suspension members 30, the electric unit 20, right and left front mounts 61R, 61L, and right and left rear mounts 65R, 65L.

As shown in FIG. 1, the vehicle body 200 includes a rear unit 10, a center unit 17, and a front unit (not shown). The rear unit 10 constitutes a rear portion of the vehicle body 200. The center unit 17 constitutes a central portion of the vehicle body 200. A front unit (not shown) constitutes a front part of the vehicle body 200. The rear unit 10, the center unit 17, and the front unit are die-cast products manufactured by integral casting. A front drive device of the vehicle 100 is mounted on the front unit. FIG. 1 shows a state in which the rear unit 10 is removed.

The rear unit 10 includes right and left rear side member parts 11R, 11L, right and left rear wheel house parts 12R, 12L, and a rear floor part 13.

Right and left rear side member parts 11R, 11L are disposed on right and left sides of the rear unit 10, and are skeletal parts extending in a vehicle front-rear direction. Coil spring seats 15R, 15L that hold the upper ends of the coil springs 72R, 72L of the right and left suspension devices 70R, 70L are disposed on the right and left rear side member portions 11R, 11L. Right and left crash boxes 14R, 14L are mounted to rear ends of right and left rear side member portions 11R, 11L. A rear bumper reinforcement 16 is attached to rear ends of the right and left crash boxes 14R, 14L.

The right and left rear wheel house portions 12R, 12L are plate-shaped portions on an arc having a semicircular cross section, the right and left rear wheel house portions 12R, 12L being connected to the right and left rear side member portions 11R, 11L on the outside of the vehicle width direction. Right and left rear wheel house portions 12R, 12L house rear wheels therein.

The rear floor portion 13 is a plate member that connects the right and left rear side member portions 11R, 11L.

The center unit 17 is connected to the rear unit 10 in a direction toward the front of the vehicle by a bolt, welding, or the like. A cabin (not shown) is mounted above the center unit 17. The battery pack 18 is mounted on the center unit 17.

The suspension member 30 is integrally provided by casting and is attached under the rear unit 10 of the vehicle body 200. The suspension member 30 is a rectangular frame-shaped member including right and left side beams 31R, 31L, a first cross member 32 in the rear, a second cross member 33, and a front cross member 34 in front of the right and left side beams 31R, 31L.

The right and left side beams 31R, 31L are disposed on both right and left sides of the vehicle 100, and are portions extending in the vehicle front-rear direction. Mount members 68 (see FIG. 2) are provided at front ends of the right and left side beams 31R, 31L, and right and left front vehicle body attachment portions 35R, 35L are mounted to the right and left rear side member portions 11R, 11L by the mount members 68. In addition, rear vehicle body attachment portions 36R, 36L that are mounted on the lower side of the rear unit 10 by the mounting member 69 (see FIG. 2) are disposed at the rear of the right and left side beams 31R, 31L. In addition, right and left vehicle rear end portions 37R, 37L of the right and left side beams 31R, 31L extend rearward from the rear vehicle body attachment portions 36R, 36L. Right and left vehicle rear end portions 37R, 37L are positioned on a vehicle rear side of vehicle front end portions of the right and left crash boxes 14R, 14L.

As shown in FIG. 2, a rear mount attachment portion 58L to which a left rear mount 65L is attached is provided at a center portion 43L of an upper portion 41L of the left side beam 31L. Similarly, a right rear mount attachment portion 58R to which a right rear mount 65R is attached is provided on the right side beam 31R. The details of the structures of the right and left side beams 31R, 31L will be described later.

The front cross member 34 is a portion that connects between the right and left front vehicle body attachment portions 35R, 35L in the vehicle width direction. The first cross member 32 in the rear is a portion that connects the right and left rear vehicle body attachment portions 36R, 36L in the vehicle width direction. The second cross member 33 is a portion that connects the right and left side beams 31R, 31L in the vehicle width direction in front of the first cross member 32.

An electric unit 20 that drives rear wheels is mounted between the front cross member 34 and the first cross member 32 of the suspension member 30. The electric unit 20 is a device in which a motor, a gear, and an inverter are integrated. Right and left drive shafts 25R, 25L are connected to the electric unit 20. The electric unit 20 is attached to the suspension member 30 by right and left front mounts 61R, 61L and right and left rear mounts 65R, 65L. The details of the electric unit 20, the right and left front mounts 61R, 61L, and the right and left rear mounts 65R, 65L will be described later.

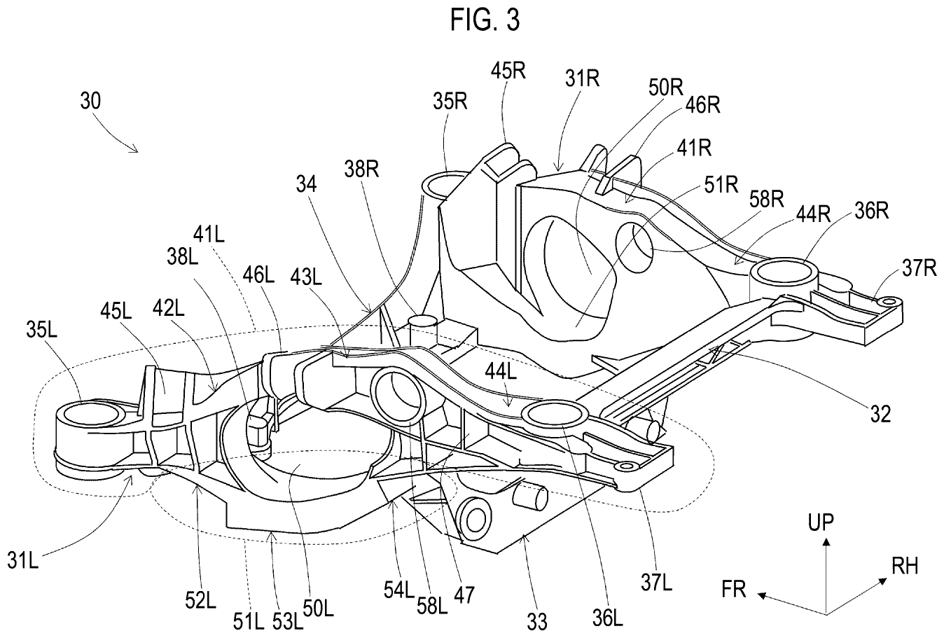

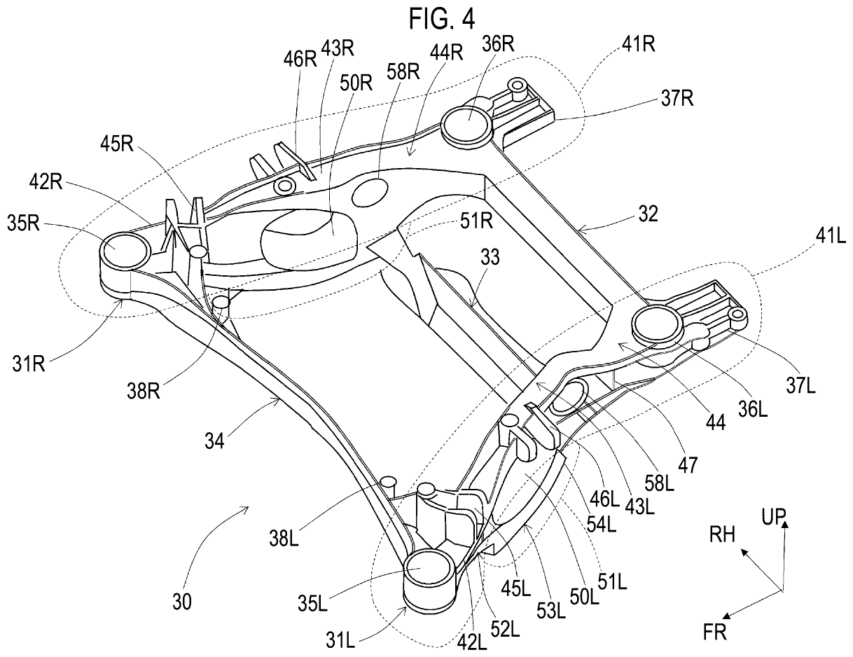

Next, the structure of the suspension member 30 will be described in detail with reference to FIGS. 3 and 4.

As described with reference to FIG. 1, the suspension member 30 is a rectangular frame-shaped member including right and left side beams 31R, 31L, a first cross member 32 in the rear, a second cross member 33, and a front cross member 34 in the front.

As shown in FIGS. 3 and 4, the left side beam 31L includes an upper portion 41L and a lower portion 51L.

The upper portion 41L includes a front portion 42L, a center portion 43L, a rear portion 44L, and a vehicle rear end portion 37L. The front portion 42L is a portion that extends rearward and obliquely upward of the vehicle from the left front vehicle body attachment portion 35L. The center portion 43L is a portion that is connected to the rear end of the front portion 42L and is curved upwardly convexly and extends horizontally toward the rear of the vehicle. The rear portion 44L is a portion that is connected to a rear end of the center portion 43L and extends horizontally toward the rear of the vehicle to the rear vehicle body attachment portion 36L. The left vehicle rear end portion 37L of the vehicle is a portion that extends horizontally rearward from the left rear vehicle body attachment portion 36L as described above.

As shown in FIGS. 3 and 4, the front portion 42L, the center portion 43L, and the rear portion 44L have a groove-shaped cross section in which the outside in the vehicle width direction is open. In addition, the rear half of the front portion 42L has a groove-shaped cross section in which the vehicle upward direction is open. Plate-like rib plates 47 extending in the vehicle width direction are provided in the front portion 42L and the rear portion 44L.

An arm connection portion 45L, 46L to which an arm of the left suspension device 70L is connected is provided on the front portion 42L and the upper portion of the center portion 43L. In addition, a cylindrical rear mount attachment portion 58L is provided at a rear portion of the center portion 43L. The rear mount attachment portion 58L is provided behind a space 50L that will be described later.

A left lower portion 51L includes a front end portion 52L, a rear end portion 54L, and a curved portion 53L. The front end portion 52L is a portion connected to the lower side of the front portion 42L of the upper portion 41L. The rear end portion 54L is a portion connected to the lower side of the rear portion 44L of the upper portion 41L. The curved portion 53L is a portion curved downwardly convex between the front end portion 52L and the rear end portion 54L. A cylindrical space 50L is provided between the upper surface of the curved portion 53L and the lower surface of the center portion 43L of the upper portion 41L. As shown in FIGS. 1 and 2, the space 50L is a hole through which the left drive shaft 25L penetrates in the vehicle width direction. The front end portion 52L, the curved portion 53L, and the rear end portion 54L have a groove-shaped cross section in which the lower side of the vehicle is open.

The right side beam 31R is symmetrical to the left side beam 31L in the right-left direction and includes an upper portion 41R and a lower portion 51R. The upper portion 41R includes a front portion 42R, a center portion 43R, a rear portion 44R, and a vehicle rear end portion 37R, and the arm connection portions 45R, 46R, and the rear mount attachment portion 58R are provided. In addition, the lower portion 51R includes a front end portion 52R, a rear end portion 54R, and a curved portion 53R. Further, a space 50R is provided between the upper portion 41R and the lower portion 51R. The space 50R is a hole through which the right drive shaft 25R penetrates in the vehicle width direction.

As shown in FIG. 4, the front cross member 34 has a T-shaped cross section including a vertical plate and a horizontal plate. As shown in FIG. 4, front mount attachment bases 38R, 38L are provided at right and left end portions of the front cross member 34. As shown in FIG. 3, the first cross member 32 has a channel-shaped cross section in which the rear of the vehicle is open. As shown in FIGS. 1 to 3, the second cross member 33 is connected to lower surfaces of rear end portions 54R, 54L of the right and left lower portions 51R, 51L, and connects the right and left side beams 31R, 31L in the vehicle width direction. The second cross member 33 has a channel-shaped cross section in which the lower side of the vehicle is open.

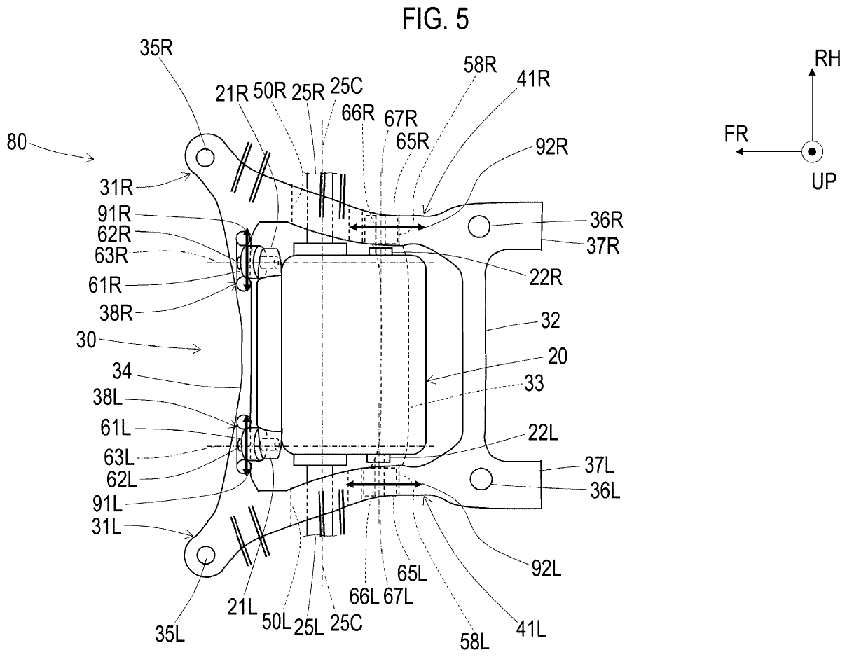

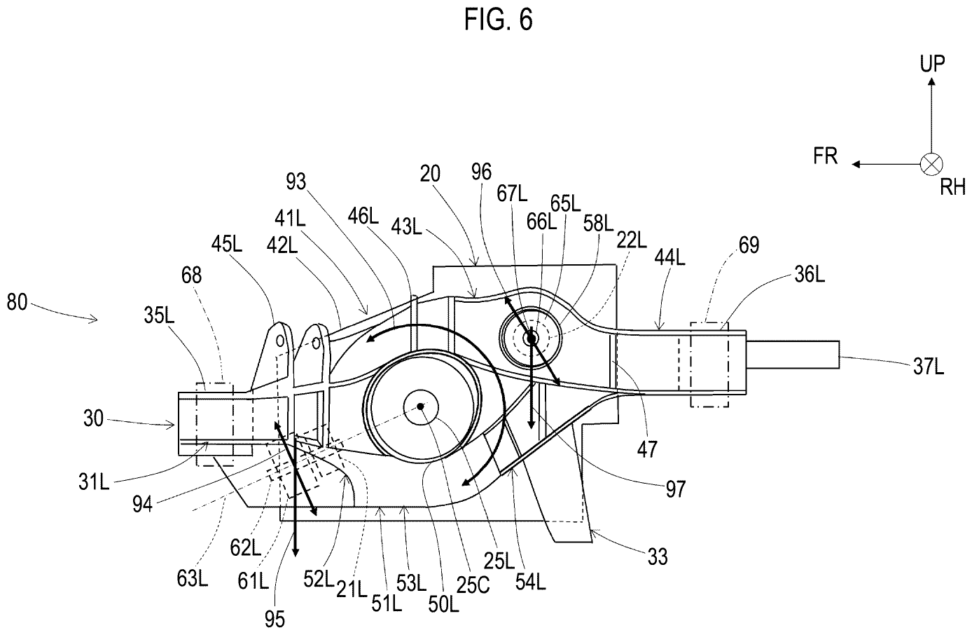

Next, the right and left front mounts 61R, 61L and the right and left rear mounts 65R, 65L will be described in detail with reference to FIGS. 5 and 6.

As shown in FIGS. 5 and 6, the left front mount 61L is a cylindrical casing in which a rubber support member is fitted. A first load-bearing shaft 62L that receives a load is fixed to the center of the rubber support member. The left front mount 61L is fixed to a front mount attachment base 38L provided at a left end portion of the front cross member 34 such that the first load-bearing shaft 62L is inclined rearward and obliquely upward of the vehicle. As shown in FIG. 5, a center line 63L of the first load-bearing shaft 62L extends in a vehicle front-rear direction rearward and obliquely upward of the vehicle such that the center line 63L passes through a center 25C of the left drive shaft 25L. The front mount mounting seat 38L is provided at a left end portion of a lower front portion of the center 25C of the drive shaft 25L. Therefore, the left front mount 61L is mounted to the left end portion of the front cross member 34 below the center 25C of the drive shaft 25L such that the first load-bearing shaft 62L extends in the direction passing through the center 25C of the drive shaft 25L.

The right front mount 61R has the same structure as the left front mount 61L, and is fixed to a front mount attachment base 38R provided at a right end portion of the front cross member 34 such that the first load-bearing shaft 62R is inclined rearward and obliquely upward of the vehicle. In addition, a center line 63R of the first load-bearing shaft 62R extends in a vehicle front-rear direction rearward and obliquely upward of the vehicle such that the center line 63R passes through a center 25C of the right drive shaft 25R.

The left rear mount 65L is the same as the left front mount 61L described above, and is a cylindrical casing in which a rubber support member is fitted. A second load-bearing shaft 66L that receives a load is fixed to the center of the rubber support member. The left rear mount 65L is fitted to the rear mount attachment portion 58L of the left side beam 31L such that the second load-bearing shaft 66L extends in the vehicle width direction. As shown in FIG. 6, the rear mount attachment portion 58L is provided above the center 25C of the drive shaft 25L at a position behind the space 50L which is a hole through which the drive shaft 25L passes. Therefore, the left rear mount 65L is attached to the left side beam 31L such that the second load-bearing shaft 66L is positioned rearward of the space 50L and above the center 25C of the drive shaft 25L in the vehicle width direction.

The right rear mount 65R has the same structure as the left rear mount 65L, and is fitted to the rear mount attachment portion 58R of the right side beam 31R such that the second load-bearing shaft 66R extends in the vehicle width direction. As shown in FIG. 5, the right and left rear mounts 65R, 65L are attached to the suspension member 30 such that the second load-bearing shafts 66R, 66L are coaxial.

As shown in FIGS. 5 and 6, the electric unit 20 includes right and left front mount brackets 21R, 21L at right and left end portions of a lower front portion. The right and left front mount brackets 21R, 21L are fastened to first load-bearing shafts 62R, 62L of right and left front mounts 61R, 61L. The weight of the electric unit 20 and the torque reaction force from the drive shafts 25R, 25L are input to the right and left front mounts 61R, 61 through the right and left front mount brackets 21R, 21L and the first load-bearing shafts 62R, 62L.

In addition, right and left rear mount brackets 22R, 22L are provided on right and left surfaces of an upper portion of the electric unit 20 behind the electric unit 20. The right and left rear mount brackets 22R, 22L are fastened to second load-bearing shafts 66R, 66L of right and left rear mounts 65R, 65L. The weight of the electric unit 20 and the torque reaction force from the drive shafts 25R, 25L are input to the right and left rear mounts 65R, 65L through the right and left rear mount brackets 22R, 22L and the second load-bearing shafts 66R, 66L.

As described above, the right and left front mounts 61R, 61L are fitted with rubber support members in which first load-bearing shafts 62R, 62L that receive the load at the center in a cylindrical casing are fixed. Therefore, the front mounts 61R, 61L have a large load bearing capacity and rigidity in the radial direction orthogonal to the first load-bearing shafts 62R, 62L, but have a small load bearing capacity and rigidity in the direction in which the first load-bearing shafts 62R, 62L extend. Similarly, in the right and left rear mounts 65R, 65L, the load bearing capacity and rigidity are large in the radius direction orthogonal to the second load-bearing shafts 66R, 66L, but the load bearing capacity and rigidity are small in the direction in which the second load-bearing shafts 66R, 66L extend.

As described above, since the center lines 63R, 63L of the first load-bearing shafts 62R, 62L extend in the vehicle front-rear direction, the load bearing capacity and the rigidity in the vehicle width direction orthogonal to the vehicle front-rear direction are increased in the right and left front mounts 61R, 61L. Therefore, the right and left front mounts 61R, 61L support the load of the electric unit 20 in the vehicle width direction, as indicated by arrows 91R, 91L in FIG. 5.

On the other hand, since the center lines 67R, 67L of the second load-bearing shafts 66R, 66L of the right and left rear mounts 65R, 65L extend in the vehicle width direction, the load bearing capacity and the rigidity in the vehicle front-rear direction orthogonal to the center lines 67R, 67L are increased. Therefore, the right and left rear mounts 65, 65L support the load of the electric unit 20 in the vehicle front-rear direction as shown by arrows 92R, 92L in FIG. 5.

In addition, as shown in FIG. 6, a center line 63L of the first load-bearing shaft 62L of the left front mount 61L extends through the center 25C of the drive shaft 25L. The torque reaction force of the drive shaft 25L is a rotation moment around the center line 67L of the drive shaft 25L as shown by an arrow 93 in FIG. 6. Therefore, the direction of the torque reaction force input from the drive shaft 25L to the left front mount 61L is a direction orthogonal to the center line 63L of the first load-bearing shaft 62L, as shown by an arrow 94 in FIG. 6. Therefore, the left front mount 61L can receive a large torque reaction force input from the drive shaft 25L.

In addition, a center line 67L of the second load-bearing shaft 66L of the left rear mount 65L extends in parallel to the center 25C of the drive shaft 25L in the vehicle width direction. Therefore, the direction of the torque reaction force input from the drive shaft 25L to the left rear mount 65L is a direction orthogonal to the center line 67L of the second load-bearing shaft 66L as shown by the arrow 96 in FIG. 6. Therefore, the left rear mount 65L can receive a large torque reaction force input from the drive shaft 25, as in the front mount 61L.

In addition, as indicated by an arrow 95 in FIG. 6, the weight of the electric unit 20 is applied in the gravity direction to the left front mount 61L. The direction in which the weight is applied is not a direction orthogonal to the first load-bearing shaft 62L, but is slightly inclined with respect to the orthogonal direction. Therefore, the load bearing capacity and the rigidity of the front mount 61L in the direction in which the weight of the front mount 61L is applied are smaller than the load bearing capacity and the rigidity in the direction orthogonal to the first load-bearing shaft 62L. However, the electric unit 20 is lighter than a drive device, such as a general engine, and the load due to the weight of the electric unit 20 is smaller than the load due to the torque reaction force. Therefore, the front mount 61L can support the weight of the electric unit 20.

In addition, as shown by an arrow 97 in FIG. 6, the weight of the electric unit 20 is applied in a direction toward the gravity to the left rear mount 65L. The direction in which the weight is applied is a direction orthogonal to the second load-bearing shaft 66L. Therefore, the rear mount 65L can support the weight of the electric unit 20.

Above, the support of the load of the electric unit 20 by the front mount 61L and the rear mount 65L on the left has been described. Since the support of the load of the electric unit 20 by the right front mount 61R and the rear mount 65R is the same as the support of the load of the electric unit 20 by the left front mount 61L and the rear mount 65L, the description thereof will be omitted.

As described above, the torque reaction force of the drive shafts 25R, 25L is applied to the suspension member assembly 80 in a direction orthogonal to the first load-bearing shafts 62R, 62L having a large load bearing capacity of the front mounts 61R, 61L. Therefore, the front mounts 61R, 61L can sufficiently receive the torque reaction force. Further, since the weight of the electric unit 20 is smaller than the torque reaction force, the weight can be supported by the front mounts 61R, 61L even when the weight is applied in a direction shifted from the center line 63R, 63L of the first load-bearing shafts 62R, 62L in the orthogonal direction. Therefore, even in a case where the front mounts 61R, 61L and the rear mounts 65R, 65L are disposed to be inclined with respect to the horizontal direction, the front mounts 61R, 61L can sufficiently receive the weight of the electric unit 20 and the torque reaction force.

Since the right and left front mounts 61R, 61L are orthogonal to the directions of the right and left first load-bearing shafts 62R, 62L in the vehicle width direction, the right and left front mounts 61R, 61L can support the load of the electric unit 20 in the vehicle width direction with high rigidity. In addition, since the directions of the right and left second load-bearing shafts 66R, 66L of the right and left rear mounts 65R, 65L are orthogonal to the vehicle front-rear direction, the rear mounts 65R, 65L can support the load of the electric unit 20 in the vehicle front-rear direction with high rigidity. Therefore, the support rigidity in the vehicle width direction of the electric unit 20 and the support rigidity in the vehicle front-rear direction can be secured. In addition, the delay in response during steering can be suppressed.

Further, since the directions of the right and left second load-bearing shafts 66R, 66L of the right and left rear mounts 65R, 65L are orthogonal to the vehicle up-down direction, the rear mounts 65R, 65L can support the weight of the electric unit 20 with high rigidity.

In the above description, the center lines 63R, 63L of the first load-bearing shafts 62R, 62L of the right and left front mounts 61R, 61L are described as extending through the center 25C of the drive shafts 25R, 25L, but the disclosure is not limited thereto. The right and left front mounts 61R, 61L may be slightly shifted from the center 25C of the drive shafts 25R, 25L as long as the center lines 63R, 63L of the first load-bearing shafts 62R, 62L are disposed to be inclined rearward and obliquely upward of the vehicle.

What is claimed is:

1. A suspension member assembly comprising:
a suspension member that is attached to a rear portion of a vehicle body;
an electric unit that is mounted on the suspension member; and
right and left front mounts and right and left rear mounts that support the electric unit, wherein:
the right and left rear mounts are attached to right and left rear upper portions of the suspension member; and
the right and left front mounts are attached to right and left front lower portions of the suspension member such that first load-bearing shafts are inclined rearward and obliquely upward of a vehicle.

2. The suspension member assembly according to claim 1, wherein:
the suspension member is a rectangular frame-shaped member including right and left side beams that are disposed on right and left sides of the vehicle and extend in a vehicle front-rear direction, and a front cross member that connects the right and left side beams in a vehicle width direction;
the right and left side beams include holes through which drive shafts connected to the electric unit pass;
the right and left rear mounts are attached to the right and left side beams such that second load-bearing shafts extend in the vehicle width direction behind the holes and above a center of the drive shafts; and
the right and left front mounts are attached to right and left end portions of the front cross member below the center of the drive shafts such that the first load-bearing shafts extend in a direction passing through the center of the drive shafts.
